(19) United States
(12) Patent Application Publication
(10) Pub. No.: US 2022/0306867 A1
(43) Pub. Date: Sep. 29, 2022

(54) MODIFIED COATING SUBSTANCES BASED ON RMA BINDERS WITH IMPROVED ADHESION ON METAL SUBSTRATES

(71) Applicant: MANKIEWICZ GEBR. & CO. (GMBH & CO. KG), HAMBURG (DE)

(72) Inventor: JUNYU WANG, BERLIN (DE)

(73) Assignee: MANKIEWICZ GEBR. & CO. (GMBH & CO. KG), HAMBURG (DE)

(21) Appl. No.: 17/617,944

(22) PCT Filed: Jun. 13, 2020
(86) PCT No.: PCT/DE2020/100490

§ 371 Date: Dec. 10, 2021

(30) Foreign Application Priority Data
Jun. 14, 2019 (DE) 10 2019 004 177.1

(51) Int. Cl. C09D 4/06; C09D 167/02; B05D 7/00

(52) U.S. Cl. CPC C09D 4/06; C09D 167/02; B05D 7/53

(57) ABSTRACT

A coating material composition includes at least one CH acidic compound A, at least one vinylogous carbonyl compound B, at least one latent base catalyst C, and at least one adhesive agent D. The at least one adhesive agent D includes at least one substituent X and at least one substituent Y. The at least one substituent X is selected to react with the at least one CH acidic compound A or with the at least one vinylogous carbonyl compound B. The at least one substituent Y is selected to physically or chemically bind to a substrate.

### CROSS REFERENCE TO PRIOR APPLICATIONS

This application is a U.S. National Phase application under 35 U.S.C. § 371 of International Application No. PCT/DE2020/100490, filed on Jun. 13, 2020 and which claims benefit to German Patent Application No. 10 2019 004 177.1, filed on Jun. 14, 2019. The International Application was published in German on Dec. 17, 2020 as WO 2020/249164 A1 under PCT Article 21(2).

### FIELD

The present invention relates to improved coating material compositions based on RMA systems as binders which cross-link through a classical Michael addition. RMA is the common abbreviation of “Real Michael Addition”. The present invention in particular relates to compositions for producing coatings with improved adhesion to metal substrates such as construction elements or components for machines and vehicles, as well as to the coatings and coating systems produced thereby.

### BACKGROUND

The term “coating material” is hereafter defined as a liquid or paste-like composition which, after having been applied to a substrate, becomes a coating with protective, decorative and/or with other specific properties through drying or curing. Coating systems are defined as several applied coverings, one on top of the other, with the single coverings (also called layers in this regard) performing different tasks.

Coating materials based on binders which cross-link in a Michael reaction have previously been described. They have the advantage of curing quickly at room temperature. The obtained coatings have high mechanical and chemical stabilities. However, common RMA coatings only adhere to metal surfaces insufficiently. The use of the common metal primers based on epoxy resin binder systems and polyurethane binder systems which are familiar to the person skilled in the art also does not improve their adhesion.

WO 2016/166365 describes the employment of adhesive agents in coating material compositions containing RMA systems as binders. The employed adhesive agents here cover both areas which react with the RMA binder system and areas which chemically or physically combine with the substrate surface. EP 3085748 describes coating systems for metal surfaces with primers or primer coats based on epoxy resin binders, and top coats or clear coats based on RMA binders, with the coating materials employed as a primer containing acrylate ester as an adhesive agent.

### SUMMARY

An aspect of the present invention is to provide improved coatings based on RMA binders, in particular coatings with improved adhesion to metal surfaces or metal substrates.

In an embodiment, the present invention provides a coating material composition which includes at least one CH acidic compound A, at least one vinylogous carbonyl compound B, at least one latent base catalyst C, and at least one adhesive agent D. The at least one adhesive agent D comprises at least one substituent X and at least one substituent Y. The at least one substituent X is selected to react with the at least one CH acidic compound A or with the at least one vinylogous carbonyl compound B. The at least one substituent Y is selected to physically or chemically bind to a substrate.

### DETAILED DESCRIPTION

The compositions according to the present invention demonstrate an improved adhesion to metal surfaces as well as to their primers based on epoxy resin binder systems, polyurethane binder systems, polyurea binder systems or polyaspartic binder systems. The compositions can, therefore, be applied to primers based on polyisocyanate cross-linking binders such as polyols, polyamines and aspartic acid esters. The term “primer” is hereafter defined as the first layer or coating of a coating system being applied to a substrate. A coating system or layer construction consists of several layers or coatings, one applied to the other.

The coating material compositions according to the present invention contain one or more CH acidic compounds A, one or more vinylogous carbonyl compounds B, one or more latent base catalysts C, as well as one or more adhesive agents D, with the adhesive agents D having one or more substituents X and one or more substituents Y. The substituents X are selected so that they react with the CH acidic compounds A or the vinylogous carbonyl compounds B, and so that they participate in the curing reaction. The substituents Y are selected so that they are physically or chemically bound to the substrate.

Suitable adhesive agents D are OH functional acrylates and OH functional CH acidic compounds. The adhesive agents D show a medium molecular weight ranging from 100 to 50,000, for example, from 150 to 10,000, for example, from 200 to 5,000. They have acrylate functionalities ranging from 1 to 50, for example, from 1 to 30, for example, from 1 to 10. Their number of acidic CH groups ranges from 1 to 50, for example, from 1 to 30, for example, from 1 to 20. They show hydroxyl numbers ranging from 30 to 500, for example, from 50 to 300, for example, from 70 to 200.

Suitable CH acidic compounds A are malonic acid esters, acetoacetic acid esters, or mixtures thereof. Malonic acid esters with oligomer and polymer substituents based, for example, on polyesters, polyurethanes, polyacrylates, epoxy resins, polyamides or polycarbonates, can, for example, be used. Malonic acid esters with oligomer and polymer substituents based on polyesters, polyurethanes and/or polycarbonates, can, for example, be used. The employed acetoacetic acid esters can, for example, contain oligomer and polymer substituents based, for example, on polyalcohols, polyvinyl alcohols, epoxy resins, hydroxy-functional polyethers, polyesters, or polyacrylates. Acetoacetic acid esters with oligomer and polymer substituents based on polyesters and/or polyacrylates, can, for example, be used. Compounds can, for example, be used which are selected from the group containing malonic acid esters with oligomer and polymer substituents based on polyesters which are obtained from the reaction of at least malonic acid, malonic acid dimethyl ester and/or malonic acid diethyl ester with hexahydrophthalic acid and/or its anhydride and neopentyl glycol, and acetoacetic acid esters with oligomer and polymer substituents based on polyesters which are obtained from the reaction of at least acetoacetic acid, acetoacetic acid methyl ester, and/or acetoacetic acid ethyl ester with hexahyrophthalic acid and/or its anhydride and neopentyl glycol.

Suitable vinylogous carbonyl compounds B are acrylates, maleates, or mixtures thereof. Unsaturated acryloyl-functional acrylates and maleates can, for example, be used. Acrylesters containing 1 to 20 carbon atoms and at least 2, for example, 2 to 6, hydroxyl groups can, for example, be used. Examples of polyesters include those obtained from the reaction of maleic acid, fumaric acid, and/or itaconic acid, or anhydrides thereof with di- or polyvalent hydroxyl compounds which may contain a monovalent hydroxyl or carboxyl compound. Examples of resins include those, like polyesters, polyurethanes, polyethers and/or alkyd resins, which correspondingly contain activated unsaturated groups such as urethane acrylates, polyether acrylates, polyfunctional polyacrylates, polyalkylmaleates, and polyacrylates which are obtained from the reaction of acrylic acid with epoxy resins. According to the present invention, butanediol diacrylate, hexanediol diacrylate, trimethylolpropane triacrylate, pentaerythritol tetraacrylate and di(-trimethylolpropane)tetraacrylate, and dipentaerythritol hexaacrylate, as well as dipropylene glycol diacrylate and tripropylene glycol diacrylate, can, for example, be used.

According to the present invention, the CH acidic compounds A and the vinylogous carbonyl compounds B are employed in a molar ratio A:B of approximately 1:1, with the molar amounts referring to the acidic protons of the compounds A and to the vinylogous carbonyl groups of the compounds B.

Ammonium and/or phosphonium carbonates are employed as latent base catalysts C according to the present invention. Suitable ammonium carbonates are, for example, tetrahexylammonium methyl carbonate, tetrahexylammonium hydrogen carbonate, tetradecanyltrihexylammonium methyl carbonate, tetradecylammonium methyl carbonate, tetrabutylammonium methyl carbonate, tetrabutylammonium ethyl carbonate, tetrabutylammonium hydrogen carbonate, tetrapropylammonium methyl carbonate, tetrapropylammonium ethyl carbonate, tetrapropylammonium hydrogen carbonate, benzyltrimethylammonium methyl carbonate, trihexylmethylammonium methyl carbonate, or trioctylmethylammonium methyl carbonate. Tetrabutylammonium methyl carbonate, tetrabutylammonium ethyl carbonate, tetrabutylammonium hydrogen carbonate, tetrapropylammonium methyl carbonate, tetrapropylammonium ethyl carbonate, tetrapropylammonium hydrogen carbonate, and mixtures thereof, can, for example, be used.

The coating materials according to the present invention have a solids content of 50 to 100%, for example, of 60 to 98%, for example, of 65 to 97%, and a pigment-to-binder ratio ranging from 0:1 to 5:1, for example, from 0:1 to 4:1, for example, from 0:1 to 3:1.

The coating materials can be employed both as top coat and as a clear coat. The term “top coat” is hereafter defined as pigmented coating materials and coatings. The term “clear coat” is hereafter defined as coating materials and coatings which do not contain any pigment. In an embodiment, the coatings according to the present invention can, for example, be employed as a top coat, for example, as a base coat in a base coat—clear coat system. In this connection, base coat—clear coat systems are multi-layer constructions showing a protective clear coat layer on a chromophoric base coat layer.

One embodiment according to the present invention provides the coating materials as two-component coating materials. The term “two-component coating materials” or “two-component lacquers” is hereafter defined as coating materials for which the curing reaction is initiated by mixing the binder component, which contains the binder, and the hardener component, which contains the hardener/catalyst.

In this connection, the binder component of the coating material composition according to the present invention contains at least:
10 to 80% by weight, for example, 15 to 50% by weight, for example, 20 to 30% by weight, of one or more CH acidic compounds A,
70% by weight, for example, 1 to 40% by weight, for example, 3 to 11% by weight, of one or more OH functional compounds D,
60% by weight, for example, 0.1 to 40% by weight, for example, 1 to 11% by weight, of one or more vinylogous carbonyl compounds B, as well as,
80% by weight, for example, 5 to 70% by weight, for example, 40 to 50% by weight, of one or more pigments,

with the indicated amounts respectively relating to the total amount of the binder component.

The binder component further contains:
0 to 10% by weight, for example, 0.5 to 5% by weight, for example, 0.5 to 1.5% by weight, of one or more light stabilizers,
0 to 20% by weight, for example, 0.01 to 10% by weight, for example, 0.1 to 6% by weight, of one or more pot-life extenders,
0 to 50% by weight, for example, 0.01 to 30% by weight, for example, 1 to 11% by weight, of one or more solvents,
0 to 20% by weight, for example, 0.01 to 10% by weight, for example, 0.5 to 5.5% by weight, of one or more wetting agents, as well as,
0 to 70% by weight, for example, 0.01 to 50% by weight, for example, 0.5 to 9.5% by weight, of one or more fillers,

with the indicated amounts respectively relating to the total amount of the binder component.

In this connection, the hardener component of the coating material composition according to the present invention contains at least 0.1 to 15, for example, 0.3 to 10, for example, 0.5 to 5% by weight, of catalyst C in a suitable solvent, with the indicated amounts relating to the total amount of the hardener component. Suitable solvents are the common esters being familiar to the person skilled in the art, such as butyl acetate, ketones, ethers, and aromatic hydrocarbons, and mixtures thereof.

In a further embodiment, the coatings according to the present invention can, for example, be employed as a clear coat. In this connection, the binder component of the clear coat composition contains:
10 to 90% by weight, for example, 15 to 80% by weight, for example, 20 to 70% by weight, of one or more CH acidic compounds A,
60% by weight, for example, 3 to 40% by weight, for example, 6 to 26% by weight, of one or more OH functional compounds D, as well as
60% by weight, for example, 0.1 to 40% by weight, for example, 5 to 15% by weight, of one or more vinylogous carbonyl compounds B,

with the indicated amounts respectively relating to the total amount of the binder component.

The binder component further contains:
0 to 10% by weight, for example, 0.5 to 5% by weight, for example, 0.5 to 1.5% by weight, of one or more light stabilizers,
0 to 20% by weight, for example, 0.01 to 10% by weight, for example, 0.1 to 6% by weight, of one or more pot-life extenders,
0 to 50% by weight, for example, 0.01 to 30% by weight, for example, 1 to 11% by weight, of one or more solvents, as well as
0 to 10% by weight, for example, 0.001 to 5% by weight, for example, 0.01 to 0.5% by weight, of one or more flow additives,

with the indicated amounts respectively relating to the total amount of the binder component.

In this connection, the hardener component of the coating material composition according to the present invention contains at least 0.1 to 15, for example, 0.3 to 10, for example, 0.5 to 5% by weight, of catalyst C in a suitable solvent, with the indicated amounts relating to the total amount of the hardener component. Suitable solvents are the common esters being familiar to the person skilled in the art, such as butyl acetate, ketones, ethers, and aromatic hydrocarbons, and mixtures thereof.

In a further embodiment, the coating material composition according to the present invention is employed for the coating of metal substrates. The coating material composition according to the present invention can, for example, be applied to a substrate surface furnished with a primer, with the latter being made of a coating material based on polyurethane binders, polyurea binders and/or polyaspartic binders, as are commonly employed for the priming of metal surfaces.

### Example 1

Top Coat

Binder Component:

| | Amount in % |
|---|---|
| Substance | by mass |
| Acure ™ 510-170 (malonate functional polyester) | 24 |
| Sartomer SR 444 (OH functional acrylate) | 6 |
| Sartomer SR 355 (tetraacrylate) | 6 |
| Hostavin ® 3212 FL (UV absorber) | 1 |
| Ethanol | 3 |
| Butyl acetate | 6 |
| Disperbyk ® 163 (wetting agent) | 3 |
| Barium sulphate | 5.5 |
| Titanium dioxide | 45 |
| Hydrophobic pyrogenic silica | 0.5 |

### Example 2

Clear Coat

Binder Component:

| | Amount in % |
|---|---|
| Substance | by mass |
| Acure ™ 510-170 (malonate functional polyester) | 60 |
| Sartomer SR 444 (OH functional acrylate) | 16 |
| Sartomer SR 355 (tetraacrylate) | 10 |
| Hostavin ® 3212 FL (UV absorber) | 1 |
| Ethanol | 3 |
| Butyl acetate | 10 |
| Tego ® Glide 432 (flow additive) | 0.2 |

The present invention is not limited to embodiments described herein; reference should be had to the appended claims.

What is claimed is:

1-10. (canceled)

11. A coating material composition comprising:
at least one CH acidic compound A;
at least one vinylogous carbonyl compound B;
at least one latent base catalyst C; and
at least one adhesive agent D,
wherein,
the at least one adhesive agent D comprises at least one substituent X and at least one substituent Y, the at least one substituent X being selected to react with the at least one CH acidic compound A or with the at least one vinylogous carbonyl compound B, and the at least one substituent Y being selected to physically or chemically bind to a substrate.

12. The coating material composition as recited in claim 11, wherein the at least one adhesive agent D is an OH functional acrylate, an OH functional CH acidic compound, or mixtures thereof.

13. The coating material composition as recited in claim 11, wherein the coating material composition is provided as a binder component and as a hardener component, the binder component comprising the at least one CH acidic compound A and the at least one vinylogous carbonyl compound B, and the hardener component comprising the at least one latent base catalyst C.

14. The coating material composition as recited in claim 13, wherein the binder component comprises:
10 to 80 wt. % of the at least one CH acidic compound A;
0.01 to 70 wt. % of the at least one adhesive agent D, wherein the at least one adhesive agent D is an OH functional acrylate, an OH functional CH acidic compound, or mixtures thereof;
0.01 to 60 wt. % of the at least one vinylogous carbonyl compound B; and
0.01 to 80 wt. % of at least one pigment,
each based on a total amount of the binder component.

15. The coating material composition as recited in claim 13, wherein the binder component comprises:
10 to 90 wt. % of the at least one CH acidic compounds A;
0.01 to 60 wt. % of the at least one adhesive agent D, wherein the at least one adhesive agent D is an OH functional acrylate, an OH functional CH acidic compound, or mixtures thereof; and
0.01 to 60 wt. % of the at least one vinylogous carbonyl compound B,
each based on a total amount of the binder component.

16. The coating material composition as recited in claim 11, wherein the at least one CH acidic compound A is a malonic acid ester, an acetoacetic acid ester, or mixtures thereof.

17. The coating material composition as recited in claim 11, wherein the at least one vinylogous carbonyl compounds B as an acrylate, a maleate, or mixtures thereof.

18. The coating material composition as recited in claim 11, wherein the at least one latent base catalyst C is at least one of an ammonium carbonate and a phosphonium carbonate.

19. A method of using the coating material composition as recited in claim 11 to coat a metal substrate, the method comprising:
providing the coating material composition as recited in claim 11;
providing the metal substrate; and
coating the substrate with the coating material composition.

20. The method of using as recited in claim 19, wherein,
the metal substrate is precoated with a primer, and
the coating material composition is coated onto the primer which was precoated on the metal substrate.
